(19) United States
(12) Patent Application Publication
(10) Pub. No.: US 2015/0337746 A1
(43) Pub. Date: Nov. 26, 2015

(54) REDUCING CONDENSATION IN AN INTERNAL COMBUSTION ENGINE OF A MOTOR VEHICLE WITH AN EXHAUST GAS RECIRCULATION SYSTEM

(71) Applicant: GM GLOBAL TECHNOLOGY OPERATIONS LLC, Detroit, MI (US)

(72) Inventor: Lutz Kilian CLOOS, Weinheim (DE)

(73) Assignee: GM GLOBAL TECHNOLOGY OPERATIONS LLC, Detroit, MI (US)

(21) Appl. No.: 14/708,907

(22) Filed: May 11, 2015

(30) Foreign Application Priority Data
May 24, 2014 (DE) 102014007943.0

(51) Int. Cl. F02D 41/00; F02M 25/07

(52) U.S. Cl. CPC F02D 41/005; F02M 25/0753; F02M 25/0754; F02M 25/0755; F02D 41/0065; F02M 2025/0757; F02M 2025/0761

(57) ABSTRACT

The present disclosure relates to a method and system for reducing condensation in an internal combustion engine of a motor vehicle including an exhaust gas recirculation system for recirculating exhaust gas of the internal combustion engine. A value of a humidity parameter is first determined, and then exhaust gas recirculation is controlled or regulated as a function of this humidity parameter value.

### CROSS-REFERENCE TO RELATED APPLICATION

This application claims priority to German Patent Application No. 102014007943.0, filed May 24, 2014, which is incorporated herein by reference in its entirety.

### TECHNICAL FIELD

The present disclosure pertains to a method and a device for reducing condensation in an internal combustion engine of a motor vehicle with an exhaust gas recirculation system and to a motor vehicle, in particular a passenger car, with the device and a computer program product for carrying out the method.

### BACKGROUND

Exhaust gas from an internal combustion engine on the one hand contains water with which fresh air that is supplied to the internal combustion engine is already charged. Through the combustion of fuel in an internal combustion engine, the exhaust gas is additionally charged with water.

If the exhaust gas charged with the water is partially recirculated through an exhaust gas recirculation system and mixed with fresh air into a mixture which is supplied to the internal combustion engine for combustion, undesirable condensation of this water can occur, in particular on a charge air cooler of an exhaust gas turbocharger through which the mixture flows, since the temperature of the mixture is particularly low there.

### SUMMARY

In accordance with an embodiment of the present disclosure an improved operation of a motor vehicle is provided. In particular, a method for reducing condensation in an internal combustion engine of a motor vehicle includes an exhaust gas recirculation system for recirculating exhaust gas of the internal combustion engine which is configured to determine a value of a humidity parameter, and control and/or regulate the exhaust gas recirculation as a function of this value of humidity. The value may in particular be a current value determined during the operation of the internal combustion engine. Equally, the value, as explained in more detail herein, may also be determined in advance, in particular estimated in particular based on a model of combustion of fuel in the internal combustion engine.

Through the control, in particular regulation, of the exhaust gas recirculation as a function of a value of a humidity parameter, in an embodiment, undesirable condensation of water in the internal combustion engine can be reduced, and in particular avoided. Accordingly, in a simple embodiment exhaust gas recirculation can for example be reduced, in particular interrupted when the value exceeds a preset limit value, be reduced proportionally to the value or the like. In an embodiment, the exhaust gas recirculation is controlled, particular regulated as a function of the value of the humidity parameter in such a manner or so that undesirable condensation of water in the internal combustion engine is reduced, and in particular avoided.

In an embodiment, the humidity parameter depends on a specific humidity which indicates the ratio of a mass of water that is present in a mass of humid fluid to the mass of humid fluid; in particular the humidity parameter can be such a specific humidity. Advantageously, such a humidity parameter is independent of a mass flow. In another embodiment, the humidity parameter can for example indicate the absolute humidity or the mass of water that is present in a mass of humid fluid or the like.

In an embodiment, the method includes determining a first value of the humidity parameter for the exhaust gas or of the exhaust gas, and determining a second value of the humidity parameter for a mixture or a mixture of fresh air and recirculated exhaust gas for combustion of fuel in the internal combustion engine. The exhaust gas recirculation is controlled as a function of this first and second value. Controlling, in particular regulating, the exhaust gas recirculation as a function of a second value of the humidity parameter of the mixture in an embodiment allows reducing condensation of water in the or out of the mixture. The second value can in particular be a value at which low condensation occurs. It can in particular be determined in the manner explained in more detail in the following. Controlling, in particular regulating, the exhaust gas recirculation as a function of a first value of the humidity parameter of the exhaust gas in an embodiment allows a simple determination of the first value, in particular through measurement in an exhaust line from an outlet of a combustion chamber of the internal combustion engine to the exhaust gas recirculation system or in an exhaust line of the exhaust gas recirculation to a fresh air line of the internal combustion engine, or through estimation explained herein.

In an embodiment, the exhaust gas recirculation is controlled, in particular regulated as a function of a quotient between the second value of the humidity parameter of the mixture and the first value of the humidity parameter of the exhaust gas. Accordingly, an exhaust gas recirculation in a simple embodiment can for example be reduced proportionally to this quotient.

In an embodiment, the method may further include determining a third value of the humidity parameter for supplied fresh air or of supplied fresh air. To this end, the temperature T_{L}, the pressure p_{L}, and the relative humidity φ_{L}, of the fresh air are measured in an embodiment and the saturated steam pressure of the fresh air p_{s,L}, is calculated, in particular according to the Magnus formula:

$${p}_{s , L} = {K}_{1} \cdot {e}^{\frac{{K}_{2} \cdot {T}_{L}}{{K}_{3} + {T}_{L}}} \qquad ( 1 )$$

with the third value or saturated steam pressure of supplied fresh air p_{s,L}, in hPa and the constant K₁, which is between 0.6 and 0.62 hPa, in particular amounts to 0.6112 hPa, the constant K₂, which is between 17 and 18, in particular amounts to 17.62, and the constant K₃, which is between 240° C. and 245° C., in particular amounts to 243.12° C., the temperature T_{L} of the fresh air being in ° C.

From this, in an embodiment, the third value of the humidity parameter, in particular a specific humidity of supplied fresh air can be advantageously determined, in particular according to the formula

$${x}_{L} = {K}_{4} \cdot \frac{{p}_{s}}{0.01 \cdot \frac{{p}_{L}}{{ϕ}_{L}} - {p}_{s}} \qquad ( 2 )$$

with the third value or the specific humidity of supplied fresh air x_{L}, the relative humidity or the saturation ratio φ_{L} of the fresh air and the constant K₄, which is between 600 and 640, in particular amounts to 622, the specific humidity and the relative humidity or the saturation ratio being between 0 and 1. Because of this, the charge of exhaust gas or mixture with water from the fresh air can be advantageously taken into account or eliminated during the comparison between second and first value of the humidity parameter.

In an embodiment, the method includes measuring temperature T_{G} and pressure p_{G} of the mixture of fresh air and recirculated exhaust gas for the combustion of fuel in the internal combustion engine, in particular on a cool place of the internal combustion engine, in particular a charge air cooler of an exhaust gas turbocharger of the internal combustion engine, in particular upstream of, on or downstream of an outlet of the charge air cooler. The second value of the humidity parameter of the mixture is determined as a function of temperature and pressure of the mixture and the third value, in particular according to the formula:

$${x}_{G} = {K}_{4} \cdot \frac{{p}_{s , G}}{{K}_{5} \cdot {p}_{G} - {p}_{s , G}} - {x}_{L} \qquad ( 3 )$$

with the second value x_{G}, the constant K₄, which is between 600 and 640, in particular amounts to 622, the constant K₅, which is between 0.8 and 1.0, in particular amounts to 1.0, the third value x_{L} and the saturated steam pressure of the mixture p_{s,G}.

The same is calculated in an embodiment according to the Magnus formula:

$${p}_{s , G} = {K}_{1} \cdot {e}^{\frac{{K}_{2} \cdot {T}_{G}}{{K}_{3} + {T}_{G}}} \qquad ( 4 )$$

with the saturated steam pressure of the mixture p_{s,G} in hPa and the constant K₁, which is between 0.6 and 0.62 hPa, in particular amounts to 0.6112 hPa, the constant K₂, which is between 17 and 18, in particular amounts to 17.62, and the constant K₃, which is between 240° C. and 245° C., in particular amounts to 243.12° C., the temperature T_{G} of the mixture being in ° C.

In an embodiment, the method includes measuring or estimating, in particular based on a model of the combustion or a combustion calculation, of a fourth value of the humidity parameter for the exhaust gas or of the exhaust gas; and determining the first value as a function of a difference between this fourth value and the third value. Alternately, the method instead includes estimating the first value, in particular based on a model of the combustion or of a combustion calculation.

As explained above, the charge with water through the fresh air can thereby be taken into account or eliminated. Accordingly, the fourth value of the humidity parameter of the exhaust gas in an embodiment depends on or indicates the mass of water in the exhaust gas, whereas the first value of the humidity parameter of the exhaust gas only depends on or indicates the mass of water introduced through the combustion of fuel in the internal combustion engine. Accordingly, the third value of the humidity parameter, which indicates the mass of water introduced by the fresh air, and the first value of the humidity parameter of the exhaust gas, which indicates the mass of water introduced through the combustion of fuel in the internal combustion engine, are added in an embodiment to form the fourth value of the humidity parameter, which indicates the sum of these masses:

x_{E}=x_{L}+x_{A}

The fourth value of the humidity parameter of the exhaust gas can be measured in an embodiment, in particular in an exhaust line of the exhaust gas recirculation system. Because of this, the fourth value in an embodiment can be advantageously determined reliably and/or precisely.

In another embodiment, the first value x_{L} or the fourth value x_{E} of the humidity parameter of the exhaust gas, is estimated based on a theoretical model of the combustion or through a combustion calculation, in particular based on the stoichiometric air requirement according to the formula:

$${x}_{A} = \frac{\frac{H}{2} \cdot \frac{{M}_{W}}{{M}_{K}}}{\frac{C + \frac{H}{4} - \frac{O}{2}}{0.21} \cdot \frac{{M}_{L}}{{M}_{K}}} \cdot {10}^{3} \qquad ( 5 )$$

for the first value, or:

$${x}_{E} = \frac{\frac{H}{2} \cdot \frac{{M}_{W}}{{M}_{K}}}{\frac{C + \frac{H}{4} - \frac{O}{2}}{0.21} \cdot \frac{{M}_{L}}{{M}_{K}}} \cdot {10}^{3} + {x}_{L} \qquad ( {5}^{′} )$$

for the fourth value with the molecular weight M_{W}=18 of water, the molecular weight Mₗ between 28 and 29.5, in particular equal to 28.84 of fresh air, the molecular weight M_{K} of the fuel, in particular:

M_{K}=12·C+H+16·O (6)

and the mole numbers H of water, C of carbon and O of oxygen of the fuel, For a usual fuel, the mole number H of water can for example be between 200 and 250, in particular equal to 215, the mole number C of carbon be between 100 and 150, in particular equal to 116, and the mole number O of oxygen be between 0 and 10, in particular equal to 2.

In an embodiment, the method includes determining a permissible quantity of the exhaust gas recirculation as a function of the first and the second value of the humidity parameter, in particular of a quotient between the second value of the humidity parameter of the mixture and the first value of the humidity parameter of the exhaust gas, in particular proportionally to this quotient, in particular according to the formula:

$${EGR}_{z} = 100 \cdot \frac{{x}_{G} - {x}_{L}}{\underbrace{{x}_{E} - {x}_{L}}_{{x}_{A}}} \qquad ( 7 )$$

A set point quantity of the exhaust gas recirculation is preset as a function of at least one operating parameter of the internal combustion engine, in particular of a rotational speed and/or a rotational moment of the internal combustion engine and/or of a charge pressure of an exhaust gas turbocharger of the internal combustion engine; limiting this set point quantity with the permissible quantity; and controlling the exhaust gas recirculation as a function of this limited quantity. It is evident that in the above equation (7) the first value x_{A} is determined as difference between the fourth x_{L}, and third value x_{L} the humidity parameter. This permits uniform treatment of measured and estimated values.

The permissible quantity and the set point quantity of the exhaust gas recirculation depend in an embodiment on a mass or volumetric flow rate of recirculated exhaust gas, in particular relative to an overall mass or volumetric flow rate of exhaust gas out of the internal combustion engine, they can in particular indicate this ratio, the so-called EGR-rate. In an embodiment, an existing exhaust gas recirculation regulation can be advantageously further used with an EGR-rate as regulating quantity. Equally, the permissible quantity and the set point quantity of the exhaust gas recirculation can also depend on a regulating quantity of an actuator, in particular of the valve position of an actuating valve of the exhaust gas recirculation system, in particular indicate the same. In an embodiment, a regulating quantity can thus be advantageously determined directly and used for controlling.

Limiting the set point quantity with the permissible quantity in an embodiment includes presetting the set point quantity EGRₛ as EGR quantity limited with the permissible quantity when or for as long as the set point quantity does not exceed the permissible quantity, and presetting the permissible quantity EGR_{z} as quantity EGR limited with the permissible quantity when or for as long as the permissible quantity exceeds the set point quantity:

$$EGR = \{ \begin{matrix}{EGR}_{S} ⇔ {EGR}_{s} < {EGR}_{z} \\ {EGR}_{z} ⇔ {EGR}_{s} \geq {EGR}_{Z}\end{matrix} \qquad ( 8 )$$

In an embodiment, the set point quantity is preset based on a preset family of characteristics in a manner known per se. Because of this, exhaust gas recirculation that is optimally adapted to an operating stage of the internal combustion engine can be preset in an embodiment.

According to an aspect of the present disclosure, a device for controlling an exhaust gas recirculation through an exhaust gas recirculation system of a motor vehicle with an internal combustion engine is equipped for carrying out a method described here. Accordingly, it includes, an actuator, in particular an actuating valve or the like, configured to control the exhaust gas recirculation and a controller configured to control the actuator as a function of the value of the humidity parameter.

In an embodiment, the device is configured to determine the first value of the humidity parameter of the exhaust gas and determine the second value of the humidity parameter of the mixture from fresh air and recirculated exhaust gas for the combustion of fuel in the internal combustion engine. The controller is configured to control the actuator as a function of this first and second value.

In an embodiment, the device is configured to determine the third value of the humidity parameter of supplied fresh air, in particular as a function of temperature, pressure and relative humidity of the fresh air. Accordingly, the device, in an embodiment, includes one or more sensors to measure temperature, pressure and relative humidity of the fresh air.

In an embodiment, the device includes one of more sensors to measure the temperature and pressure of the mixture, in particular on a charge air cooler of an exhaust gas turbocharger of the internal combustion engine such that the second value may be determined as a function of temperature and pressure of the mixture and of the third value.

In an embodiment, the device is configured to measure or estimating the fourth value of the humidity parameter of the exhaust gas such that the first value is determined as a function of a difference between this fourth value and the third value. In another embodiment, the device is configured to estimate the first value, in particular without the device estimating a fourth value of the humidity parameter of the exhaust gas.

In an embodiment, the device is further configured to determine a permissible quantity of the exhaust gas recirculation as a function of the first and second value of the humidity parameter. A set point quantity of the exhaust gas recirculation is preset as a function of at least one operating parameter of the internal combustion engine, in particular of a rotational speed and/or a rotational moment of the internal combustion engine and/or a charge pressure of an exhaust gas turbocharger of the internal combustion engine. This set point quantity may be limited with the permissible quantity, wherein the controller is equipped in order to control the actuator as a function of this limited quantity.

In terms of the present disclosure, the device may be designed as hardware and/or software, in particular include an in particular digital processing unit in particular microprocessor unit (CPU) preferentially data or signal-connected to a storage and/or bus system and/or one or multiple programs or program modules. The CPU can be designed for executing commands which are implemented as a program stored in a storage system, detecting input signals from a data bus and/or emitting output signals to a data bus. A storage system can include one or multiple in particular different storage media, in particular optical, magnetic, solid-state and/or other non-volatile media. The program can be of such a nature that it embodies or is capable to carry out the methods described here, so that the CPU can carry out the steps of such methods and thereby in particular control, in particular regulate the exhaust gas recirculation.

The internal combustion engine, in an embodiment, is a spark-ignition or diesel engine, in particular with an exhaust gas turbocharger, in particular with a charge air cooler. The exhaust gas recirculation, in an embodiment, is a so-called low-pressure exhaust gas recirculation system with an exhaust line, which connects an exhaust gas passage downstream after a combustion engine, in particular after a turbine of an exhaust gas turbocharger, of the internal combustion engine, with a fresh air passage upstream in front of the combustion chamber, in particular in front of a compressor of the exhaust gas turbocharger.

### BRIEF DESCRIPTION OF THE DRAWINGS

The present disclosure will hereinafter be described in conjunction with the following drawing figures, wherein like numerals denote like elements.

FIG. 1 schematically illustrates an internal combustion engine of a motor vehicle with an exhaust gas recirculation system and a device according to an embodiment of the present disclosure; and

FIG. 2 illustrates a flow diagram of a method according to an embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description.

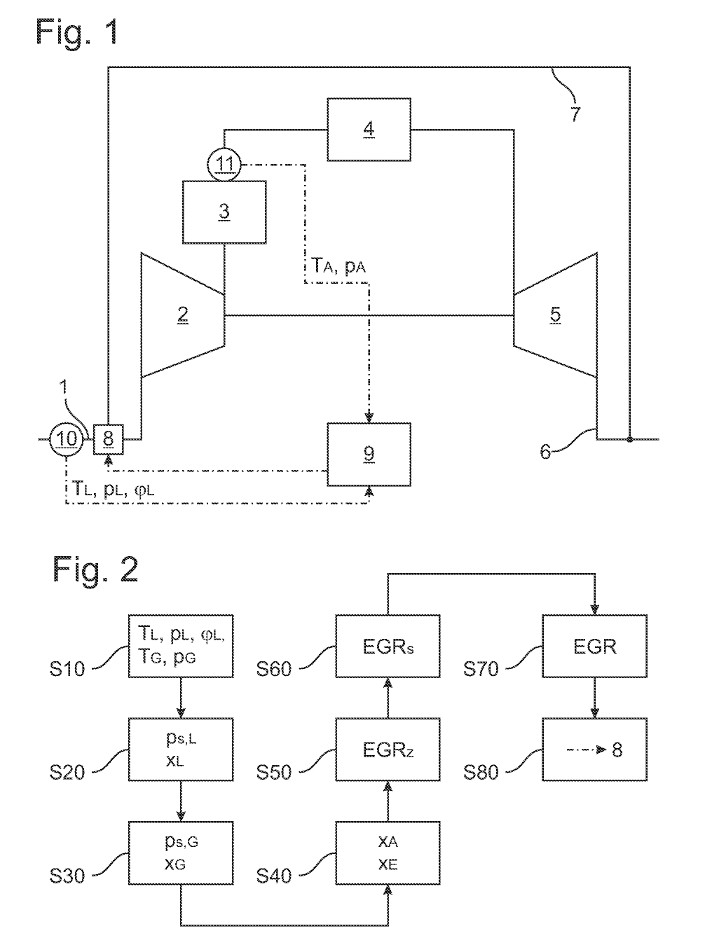

FIG. 1 shows an internal combustion engine of a motor vehicle with an exhaust gas recirculation system and a device according to an embodiment of the present disclosure.

The internal combustion engine includes a fresh air passage 1 for drawing in ambient air as fresh air, a compressor 2 of an exhaust gas turbocharger downstream after the fresh air passage 1, a charge air cooler 3 of the exhaust gas turbocharger downstream after the compressor 2, a combustion chamber 4, a turbine 5 of the exhaust gas turbocharger downstream after the combustion chamber 4 and an exhaust gas passage 6 downstream after the turbine 5.

The exhaust gas recirculation system includes an exhaust line 7, which connects the exhaust gas passage 6 downstream after the turbine 5 of the exhaust gas turbocharger to the fresh air passage 1 upstream in front of the compressor 2 of the exhaust gas turbocharger. In the exhaust line 7, an actuating valve 8 is arranged, which is activated by an electronic control unit ECU 9 of the motor vehicle and controls exhaust gas recirculation of exhaust gas from the exhaust gas passage 6 into the fresh air passage 1.

The control unit 9 is operably connected to one or more sensors, singly indicated at 10, for measuring the temperature T_{L}, the pressure p_{L} and the relative humidity φ_{L} of fresh air in the fresh air passage 1, and a one or more sensors, singly indicated at 11, for measuring the temperature T_{G} and the pressure p_{G} of mixture of fresh air and recirculated exhaust gas at an outlet of the charge air cooler 3.

FIG. 2 shows the sequence of a method according to an embodiment of the present disclosure that is carried out by the above-described device. In a step S10, the temperature T_{L}, the pressure p_{L} , and the relative humidity φ_{L} of fresh air in the fresh air passage 1 are measured by the sensor 10 and the temperature T_{G} and the pressure p_{G} of mixture of fresh air and recirculated exhaust gas measured by sensor 11 at an outlet of the charge air cooler 3 and transmitted to the ECU 9.

The ECU 9 initially determines in a step S20 the saturated steam pressure of supplied fresh air p_{s,L} from the measured temperature T_{L} according to the above equation (1) and from this and the measured pressure p_{L} and the measured relative humidity φ_{L} according to the above equation (2) the specific humidity of supplied fresh air x_{L} as third value of a humidity parameter, which in the exemplary embodiment is the specific humidity:

$$x = \frac{{m}_{W}}{{m}_{F}}$$

with the mass m_{W} of the water, which is present in a certain mass m_{F} of humid fluid and is between 0 and 1, wherein for dry fluid x=0 and for air-free fluid or liquid water x=1.

In a step S30, the ECU 9 initially determines from the measured temperature T_{G} according to the above equation (4) the saturated steam pressure of the mixture p_{s,G} and from this and the measured pressure p_{G} according to the above equation (3) a second value x_{G} of the humidity parameter x of the mixture of fresh air and recirculated exhaust gas at the outlet of the charge air cooler 3.

In a step S40, the ECU 9 determines from a combustion calculation according to the above equations (5′) and (6), a fourth value x_{E} of the humidity parameter of the exhaust gas. Alternatively, this can also be measured by the sensor 11. Alternatively, the ECU 9 in step S40 directly determines from a combustion calculation according to the above equations (5) and (6) a first value x_{A} of the humidity parameter of the exhaust gas.

In a step S50, the ECU 9 determines a permissible quantity EGR_{z} of the exhaust gas recirculation, in particular a permissible EGR-rate, which indicates a ratio of recirculated exhaust gas to exhaust gas from the internal combustion engine, according to the above equation (7). As explained above, the first value x_{A} is determined here by subtracting the third value x_{L} from the fourth value x_{E}. When in step S40 the first value x_{A} of the humidity parameter of the exhaust gas has already been determined, the subtraction of x_{L} can be omitted in step S50 according to the above equation (7).

In a step S60, the ECU 9 presets a set point quantity of the exhaust gas recirculation in the form of a set point EGR-rate, EGRₛ based on a family of characteristics in a manner known per se. The set point quantity is used to limit the ECU 9 in a step S70 with the permissible quantity EGR_{z} determined in step S50 according to the above equation (8) and in a step S80 activates the actuating valve 8 in such a manner that the exhaust gas recirculation has this limited EGR-rate EGR.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-14. (canceled)

15. A method for reducing condensation in an internal combustion engine of a motor vehicle having an exhaust gas recirculation system for recirculating exhaust gas of the internal combustion engine, the method comprising:
determining a humidity parameter value for the exhaust gas; and
controlling the exhaust gas recirculation system as a function of the humidity parameter value.

16. The method according to claim 15, wherein the method further comprises:
determining a first value of the humidity parameter for the exhaust gas;
determining a second value of the humidity parameter for a mixture of fresh air and recirculated exhaust gas for the combustion of fuel in the internal combustion engine; and
controlling the exhaust gas recirculation as a function of the first and second values.

17. The method according to claim 16, wherein the method further comprises:
determining a third value of the humidity parameter for supplied fresh air; and
controlling the exhaust gas recirculation as a function of the first, second and third values.

18. The method according to claim 17, wherein the third value is determined as a function of the temperature, pressure and relative humidity of the fresh air.

19. method according to claim 17, wherein the method further comprises:
measuring the temperature and pressure of the mixture of fresh air and recirculated exhaust gas; and
determining the second value as a function of temperature and pressure of the mixture and the third value.

20. The method according to claim 19, wherein the temperature and pressure of the mixture is measured on a charge air cooler of an exhaust gas turbocharger of the internal combustion engine.

21. The method according to claim 17, wherein the method further comprises:
measuring a fourth value of the humidity parameter for the exhaust gas; and
determining the first value as a function of a difference between the fourth value and the third value.

22. The method according to claim 17, wherein the method further comprises:
estimating a fourth value of the humidity parameter for the exhaust gas; and
determining the first value as a function of a difference between the fourth value and the third value.

23. The method according to claim 16, wherein the method further comprises:
determining a permissible quantity of the exhaust gas recirculation as a function of the first and the second value of the humidity parameter;
presetting a set point quantity of the exhaust gas recirculation as a function of at least one operating parameter of the internal combustion engine;
limiting the set point quantity with the permissible quantity; and
controlling the exhaust gas recirculation as a function of the limited set point quantity.

24. The method according to claim 23, wherein the at least one operating parameter comprises a rotational speed of the internal combustion engine, a rotational moment of the internal combustion engine or a charge pressure of an exhaust gas turbocharger of the internal combustion engine.

25. A computer program product comprising a controller operably coupled to a non-transitory computer-readable medium having a program code stored thereon for carrying out the method according to claim 15.

26. A device for controlling an exhaust gas recirculation through an exhaust gas recirculation system of an internal combustion engine of a motor vehicle comprising:
an actuator configured to regulate exhaust gas recirculation; and
a controller configured to determine a humidity parameter value and control the actuator as a function of the humidity parameter value.

27. The device according to claim 26, wherein the controller is further configured to determine a first value of the humidity parameter for the exhaust gas and a second value of the humidity parameter for a mixture of fresh air and recirculated exhaust gas for the combustion of fuel in the internal combustion engine, wherein the controller controls the actuator as a function of the first and second values.

28. The device according to claim 27, wherein the controller is further configured to determine a third value of the humidity parameter for supplied fresh air and control the actuator as a function of the first, second and third values.

29. The device according to claim 28, further comprising at least one sensor configured to measure the temperature, pressure and relative humidity of the fresh air, wherein the controller operably coupled to the at least one sensor for determining the third value.

30. The device according to claim 28, further comprising at least one sensor configured to measure the temperature and pressure of the mixture, wherein the controller is operably coupled to the at least one sensor for determining the second value as a function of temperature and pressure of the mixture and the third value.

31. The device according to claim 30, wherein the at least one sensor measure the temperature and pressure of the mixture on a charge air cooler of an exhaust gas turbocharger of the internal combustion engine.

32. The device according to claim 28, wherein the controller is further configured to determine a fourth value of the humidity parameter for the exhaust gas and determine the first value as a function of a difference between the fourth value and the third value.

33. The device according to claim 27 wherein the controller is further configured to determine a permissible quantity of the exhaust gas recirculation as a function of the first and second values of the humidity parameter, preset, a set point quantity of the exhaust gas recirculation as a function of at least one operating parameter of the internal combustion engine, and limit the set point value with the permissible quantity, wherein the controller controls control the actuator as a function of the limited set point value.

34. The device according to claim 33 wherein the at least one operating parameter comprises a rotational speed of the internal combustion engine, a rotational moment of the internal combustion engine or a charge pressure of an exhaust gas turbocharger of the internal combustion engine.
